(19) United States
(12) Patent Application Publication
(10) Pub. No.: US 2013/0151079 A1
(43) Pub. Date: Jun. 13, 2013

(54) Controllers for and Methods of Controlling Electric Power Assisted Steering Systems

(71) Applicants: Timothy Sworn, Birmingham (GB); Phillip March, Leicester (GB); Birk Junghanns, Birmingham (GB)

(72) Inventors: Timothy Sworn, Birmingham (GB); Phillip March, Leicester (GB); Birk Junghanns, Birmingham (GB)

(73) Assignee: TRW LIMITED, Solihull, West Midlands (GB)

(21) Appl. No.: 13/574,078

(22) PCT Filed: Jan. 20, 2011
(86) PCT No.: PCT/GB2011/050091

§ 371 Date: Oct. 11, 2012

(30) Foreign Application Priority Data
Jan. 21, 2010 (GB) 1000948.8

(51) Int. Cl. B62D 6/08; B62D 5/04

(52) U.S. Cl. CPC B62D 6/08; B62D 5/0463
USPC 701/42

(57) ABSTRACT

A controller for an electric power assisted steering system includes a steering mechanism and an electric motor that can apply an assistance torque to the steering mechanism. The controller has an input for an input torque signal indicative of the torque applied by a user to the steering mechanism and an output for an assistance torque demand indicative of the assistance torque to be applied to the steering mechanism by the electric motor. The controller includes: a first subcontroller having an input for the input torque signal, an output for a first assistance torque and a process arranged to determine the first assistance torque; a second subcontroller having an input for the input torque signal, an output for a second assistance torque and a processor arranged to determine the second assistance torque; and a blending unit, which provides as an output the assistance torque demand. The blending unit combines the first and second assistance torques in time-varying proportions in order to determine the assistance torque demand.

This invention relates to controllers for electric power assisted steering systems, methods of controlling electric power assisted steering systems, and an electric power assisted steering system comprising such a controller.

Electric power assisted steering (EPAS) systems are well known in the prior art. Generally, the steering mechanism of a vehicle couples rotational movement of a steering wheel into movement of the road wheels of the vehicle. An electric motor can be used to assist the driver with the movement of the wheels by applying a torque to the system that is coupled into the steering mechanism. A torque sensor in part of the steering mechanism indicates the torque being input to the steering mechanism by the driver; the system uses this to determine how much assistance torque to apply using the motor.

In a typical EPAS system, the driver controls the steering via a handwheel. A torque sensor is provided, as discussed above, in the steering mechanism of a vehicle; typically this could be located in the handwheel, steering column or pinion assembly. This produces a torque signal T_{D} indicative of the torque applied to the steering mechanism by the driver; this can be referred to as the assistance torque demand. A torque controller uses T_{D} to generate an assistance torque demand T_{A}. This assistance torque T_{A} is indicative of a force to be generated by the motor in order to assist the driver with turning the steering wheel in order to move the road wheels of the vehicle.

The assistance torque thus generated is generally scaled so that it represents the reduction that is to be achieved in the torque in the steering column and thus the assistance to the driver. The assistance torque T_{A} is typically dependent upon not only the measured torque T_{D} but also the vehicle speed. Furthermore, the assistance torque T_{A} is generally boosted from the measured torque T_{D} by a non-linear boost function, such as is described in European Patent Application publication no EP 0 947 413.

In the motor controller circuit 103, the assistance torque demand T_{A} is converted into a set of signals for controlling the motor 104 so that it produces an amount of torque proportional to the assistance torque demand T_{A} but scaled by factors depending on the mechanical connection of the motor to the steering mechanism; for example, the mechanical ratio of any gearbox used, the mechanical polarity of the gearbox and the efficiency of the mechanical driveline. In some cases, the steering ratio is a non-linear function of the steering angle; in these instances, it is possible to schedule the calculation according to a measurement of steering angle. In other cases it may be desirable to compensate the conversion between T_{A} and the motor control variables by other parameters that are known to affect the physical parts, for example the motor temperature.

In general, a steering system may comprise a number of transformations between linear (or quasi-linear) motion and rotary motion. Typically in a steering system with a rack & pinion steering gear, the driver will apply a force to the rim of a handwheel that is translated into a torque in the steering column. This torque is substantially transmitted to the pinion of the steering gear (there is some modulation and frictional loss in the intermediate shaft). The rack and pinion mechanism translates the applied pinion torque into a rack force. The rack force is then substantially coupled into the steering arms of the road wheel hubs by a linkage (there can be modulation of the forces by the kinematics of the suspension).

The steering arms translate the linkage forces into a torque that is substantially applied along the steering axis of the suspension and hence onto the contact patch between the tyre and road. An electric power assisted steering (EPAS) system typically measures the input torque applied to the handwheel, column or pinion; and applies assistance power via a mechanism on the column, pinion, steering gear or directly about the road wheel steering axis.

It will be recognised by those skilled in the art that it is possible to relate the various forces in the system to the various torques in the system according to the physical dimensions of the active parts in the mechanism. Similarly the electro-motive force from the assistance motor can be substantially related back to an equivalent torque that is applied on the handwheel.

It is therefore to be appreciated that the EPAS system is a closed-loop control system, where the torque input by a user is affected by the assistance torque applied by the motor and vice versa. The behaviour of the feedback loop—the level of assistance, level of damping of the system to input torques and so on can be varied to suit a user; together the various adjustable parameters can be referred to as a steering feel or steering tune.

It is important to ensure that the feedback loop within any EPAS system is stable, so that the response of the EPAS system to any expected input is predictable and safe. For this reason, whilst it is possible to provide EPAS systems with multiple steering feels (sports, standard, luxury, low surface adhesion), it has not generally been possible to switch these with the vehicle in motion, because it is not possible to ensure that the response of the system would be stable. Users will typically view the limitation of only being able to select a different steering feel when stopped or at start up of their vehicle unnecessarily restrictive.

According to a first aspect of the invention, there is provided a controller for an electric power assisted steering system comprising a steering mechanism which operatively connects a steering wheel to road wheels of a vehicle, and an electric motor operatively connected to the steering mechanism in order to apply an assistance torque to the steering mechanism, the controller having an input for an input torque signal indicative of the torque applied by a user to the steering mechanism and an output for an assistance torque demand indicative of the assistance torque to be applied to the steering mechanism by the electric motor,
in which the controller comprises:
a first subcontroller having an input for the input torque signal, an output for a first assistance torque and a processor arranged to determine the first assistance torque based upon the input torque signal;
a second subcontroller having an input for the input torque signal, an output for a second assistance torque and a processor arranged to determine the second assistance torque based upon the input torque signal; and
a blending unit, which has an input for each of the first and second assistance torques and which provides as an output the assistance torque demand, the blending unit arranged to combine the first and second assistance torques in time-varying proportions in order to determine the assistance torque demand.

As such, this allows the assistance torque to be calculated twice, potentially with different steering feels, and then combined to provide the assistance torque demand. This can ameliorate any problems with switching a single controller between different steering feels whilst a controller is in use.

As such, each of the first and second subcontroller may have an active state, in which the respective subcontroller determines the respective assistance torque dependent upon the input torque signal and an inactive state where it does not determine the respective assistance torque. Typically, at least one of the first and second subcontrollers may be in the active state at any given time. This means that, when it is desired to change the steering feel, a non-active subcontroller can be started up, without any issues arising from switching a controller in use.

Should one of the subcontrollers be in the inactive state, the blending unit may be arranged so as to exclude the output of subcontroller in the inactive state from the assistance torque demand. The blending unit may be arranged so as to exclude the output of a subcontroller that has switched from the inactive state to the active state until a predetermined period of time has elapsed. This will allow the assistance torque output by the newly-active subcontroller to stabilise before it is used in the assistance torque demand.

Furthermore the blending unit may be arranged to as to exclude the output of a subcontroller that has switched from the inactive state to the active state until any or all of the following criteria are satisfied: the speed of the vehicle is less than a threshold; the speed (typically angular) of part of the steering mechanism is less than a threshold; and the input torque signal is less than a threshold.

The blending unit may be arranged so as to introduce an increasing proportion in the assistance torque demand of the assistance torque of one subcontroller, as it decreases the proportion in the assistance torque demand of the other subcontroller. Typically, the subcontroller whose assistance torque is increasingly used in the assistance torque demand will have more recently switched from the inactive state to the active state.

The proportions introduced by the blending unit may vary from entirely from one subcontroller to entirely from the other subcontroller. The period of which this occurs may depend upon the difference between the first and second assistance torques, typically when the variation from one subcontroller to the other commences.

The blending unit may be arranged so as to additively combine the first and second assistance torque in order to output the assistance torque demand. Preferably, the blending unit combines the first and second assistance torques according to:

k(αT₁+(1−α)T₂),

where T₁ is the first assistance torque, T₂ is the second assistance torque, k is a constant (typically 1) and α is a function of time. Typically, α will be sigmoid with time. This value may give the assistance torque demand.

The blending unit may further comprise at least one input for at least one additional torque demand, which the blending unit is arranged to combine with the first and second assistance torques in order to provide the assistance torque demand. This will allow components calculated independently of the first and second subcontrollers to be included in the assistance torque demand.

Each of the subcontrollers may have an input for a steering feel. The steering feel may comprise at least one of the following parameters: the level of damping required, the level of assistance torque required for a given input torque signal, the time constant of a frequency-dependent filter used in the determination of the assistance torque or any other parameter used in the determination of the assistance torque.

The controller may be provided as an integrated circuit, typically an application specific integrated circuit. However, the controller may also be provided as a general purpose processor, provided with executable instructions such as software which cause the processor to carry out the functions of the first and second processors and the blending unit; as such, the same processor may form the first and second processors and the blending unit.

According to a second aspect of the invention, there is provided an electric power assisted steering system for a vehicle, comprising:
a steering mechanism arranged to operatively connect a steering wheel to road wheels of the vehicle;
an electric motor operatively connected to the steering mechanism in order to apply an assistance torque to the steering mechanism; and
a controller according to the first aspect of the invention;
in which the controller is arranged to control the assistance torque applied to the steering mechanism by the electric motor according to the assistance torque demand.

The electric power assisted steering system may comprise a sensor for the input torque signal, which may comprise a torque sensor arranged to determine the torque in part of the steering mechanism. Typically, the part will be part of a steering column.

According to a third aspect of the invention, there is provided a method of operating an electric power assisted steering system comprising a steering mechanism which operatively connects a steering wheel to road wheels of a vehicle, and an electric motor operatively connected to the steering mechanism in order to apply an assistance torque to the steering mechanism,
the method comprising:
measuring an input torque indicative of the torque applied by a user to the steering mechanism;
determining, from the input torque, a first assistance torque;
at the same time determining, from the input torque, a second assistance torque;
blending the first and second assistance torques in time-varying proportions in order to determine the assistance torque demand;
and operating the motor in accordance with the assistance torque demand.

As such, this allows the assistance torque to be calculated twice, potentially with different steering feels, and then combined to provide the assistance torque demand. This can ameliorate any problems with switching a single controller between different steering feels whilst a controller is in use.

The method may comprise the step of only determining one of the first or second assistance torques for a period of time. Typically, only the assistance torque that is being determined will be included in the assistance torque demand during that period of time. Furthermore, the step of blending may comprise excluding an assistance torque determination of which has been commenced until a predetermined period of time has elapsed after the period of time in which only one of the assistance torques has been determined. This will allow the newly-active assistance torque to stabilise before it is used in the assistance torque demand.

Furthermore the step of blending may comprise excluding the assistance torque determination of which has been commenced until any or all of the following criteria are satisfied: the speed of the vehicle is less than a threshold; the speed (typically angular) of part of the steering mechanism is less than a threshold; and the input torque is less than a threshold.

The step of blending may comprise introducing an increasing proportion in the assistance torque demand of one of the first and second assistance torques, as the proportion in the assistance torque demand of the other of the first and second assistance torques is decreased. Typically, determination of the assistance torque which is increasingly used in the assistance torque demand will have more recently commenced.

The proportions introduced in the blending step may vary from entirely from one of the first and second assistance torques to entirely from the other of the first and second assistance torques. The period of which this occurs may depend upon the difference between the first and second assistance torques, typically when the variation from one assistance torque to the other commences.

The step of blending may comprise additively combining the first and second assistance torques in order to determine the assistance torque demand. Preferably, the first and second assistance torques are combined according to:

k(αT₁+(1−α)T₂),

where T₁ is the first assistance torque, T₂ is the second assistance torque, k is a constant (typically 1) and α is a function of time. Typically, α will be sigmoid with time. This value will typically be used as the assistance torque demand.

The step of blending may further comprise combining at least one additional torque demand with the first and second assistance torques in order to provide the assistance torque demand. This will allow components calculated independently of the first and second subcontrollers to be included in the assistance torque demand.

There now follows, by way of example only, description of an embodiment of invention, described with reference to the accompanying drawings, in which:

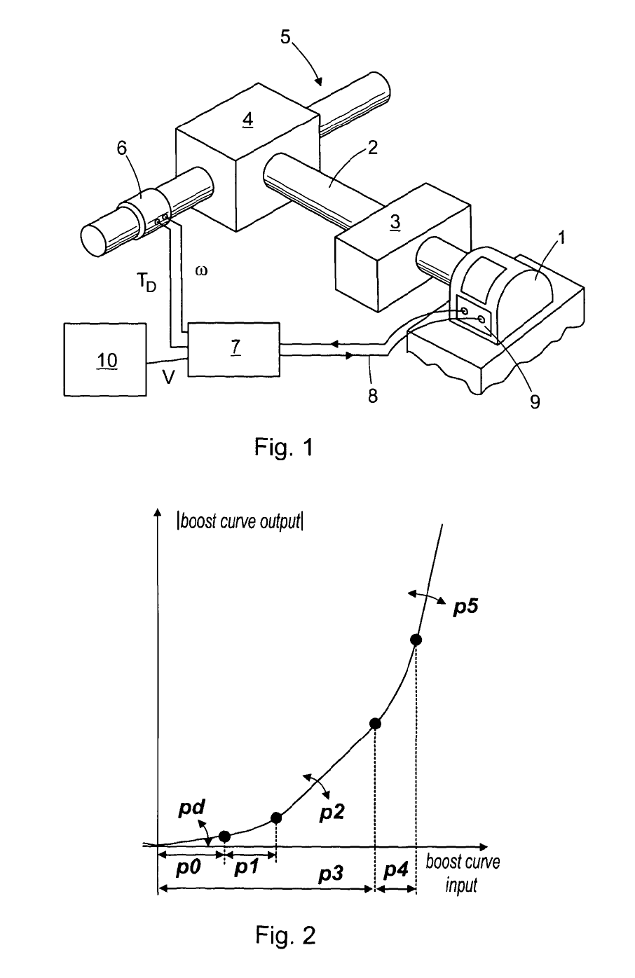

FIG. 1 shows an electric power assisted steering (EPAS) system according to an embodiment of the invention;

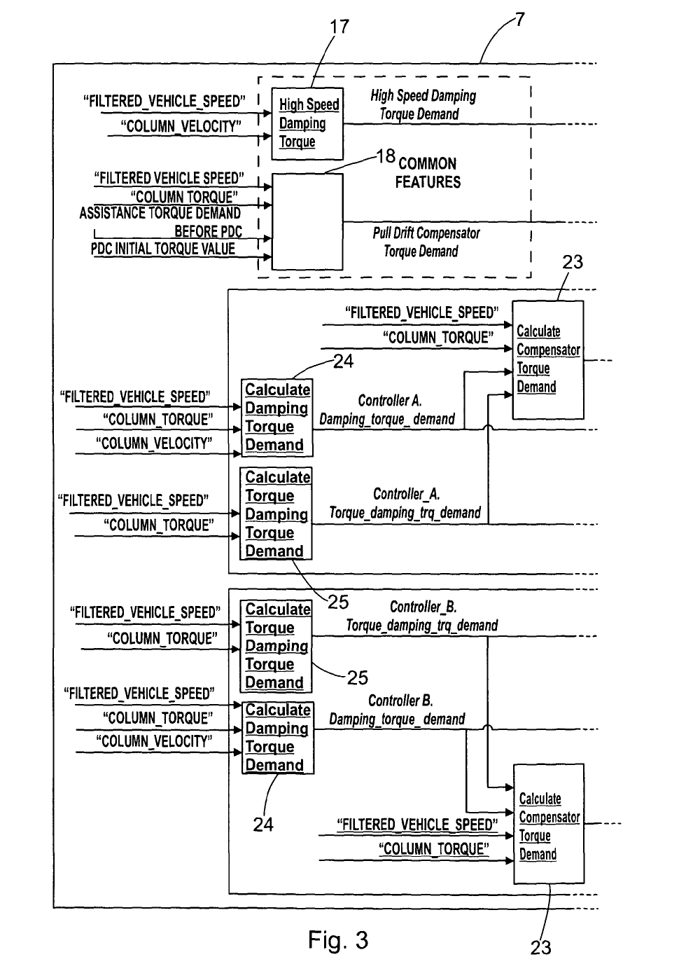

FIG. 2 shows the boost curve used in the EPAS system of FIG. 1;

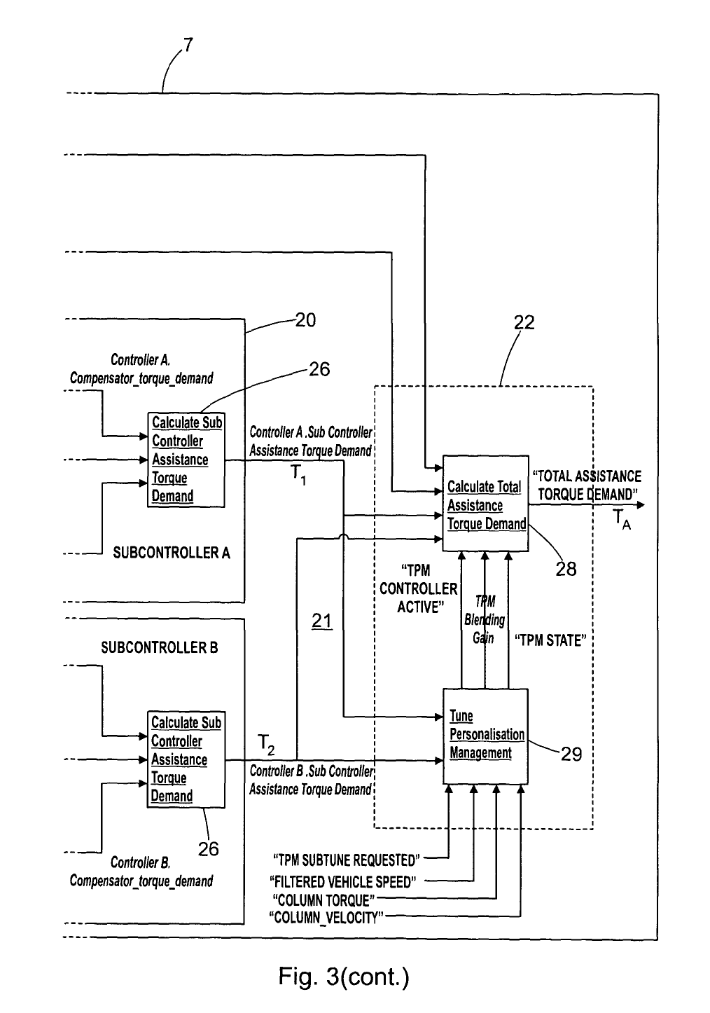

FIG. 3 shows schematically the controller of the EPAS system of FIG. 1;

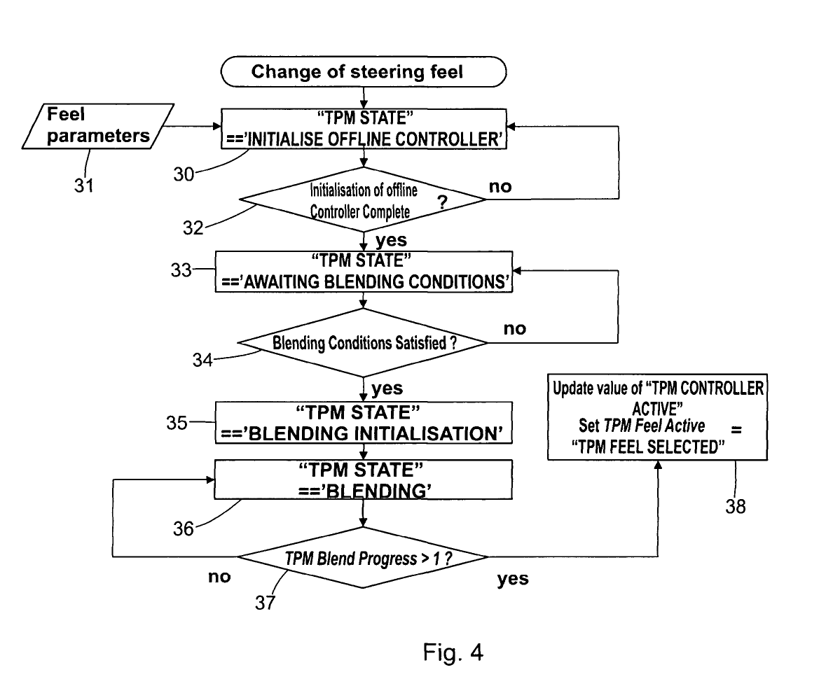

FIG. 4 shows a flow chart showing the operation of the blending unit of the EPAS system of FIG. 1; and

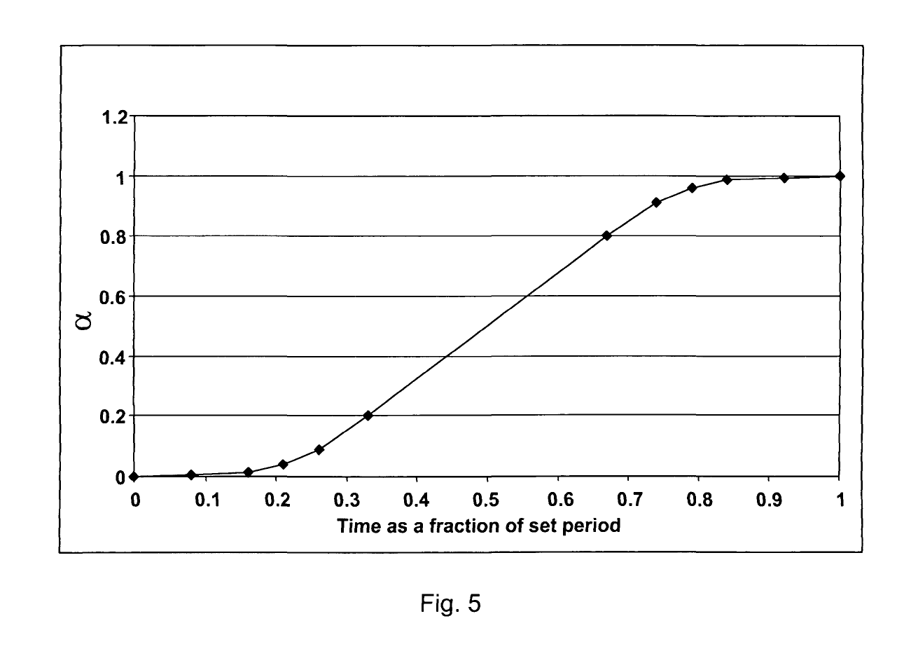

FIG. 5 shows a graph of the proportion of the output of the two subcontrollers of the EPAS system of FIG. 1 used in the assistance torque demand.

An electric power assisted steering (EPAS) system according to an embodiment of the invention is shown in the accompanying drawings, and in particular in overview in FIG. 1 of the accompanying drawings. The EPAS system comprises an electric motor 1, which acts upon a drive shaft 2 through a gearbox 3. The drive shaft 2 terminates with a worm gear 4 that co-operates with a wheel provided on a portion of a steering column 5 or a shaft operatively connected to the steering column.

The steering column 5 carries a torque sensor 6 that is adapted to measure the torque carried by the steering column that is produced by the driver of the vehicle as the steering wheel (not shown) and hence steering column is turned against the resisting force provided by the vehicle's road wheels (also not shown). The output signal—referred to herein as the input torque signal T_{D}—from the torque sensor 6 is fed to a first input of a controller 7.

The controller 7 also has inputs for the vehicle speed V, measured using a vehicle speed sensor 10 and the steering column velocity ω, measured using the torque sensor 6, which also provides an output indicative of the steering column velocity.

The controller 7 acts upon the input signals to produce, as its output, an assistance torque demand signal T_{A} 8 that is passed to a motor controller 9. The motor controller 9 converts the assistance torque demand signal 8 into drive currents for the electric motor 1. The motor 1 is therefore driven in accordance with the assistance torque demand signal 8.

The controller 7 is typically implemented as an application specific integrated circuit (ASIC), but could be formed as a general purpose microprocessor programmed to carry out the functions below.

The functionality of the controller is depicted schematically in FIG. 3 of the accompanying drawings. The controller 7 is of the general form of two subcontrollers 20 and 21, and a blending unit 22. The subcontrollers each take as inputs the vehicle speed V (filtered so as to remove high frequency components), the input torque signal T_{D} and the steering column velocity ω. From these variables, each of the subcontrollers determines an assistance torque, referred to as T₁ from subcontroller 20 and T₂ from subcontroller 21. The blending unit 22 combines T₁ and T₂ in time varying components and outputs the result as the assistance torque demand T_{A}.

The method by which each subcontroller determines its respective assistance torque T₁, T₂ is not essential to the invention, but we disclose below one suitable method. Other methods of calculating the assistance torque can be provided, as set out in, for example, the International Patent Application publications numbers WO2008/071926 and WO2008/044010.

Each subcontroller performs the same basic calculation, although the parameters of each subcontroller will be different, in order to provide a different steering feel or steering tune. The assistance torque of each subcontroller represents the additive combination of a number of components. The first component is generated by compensator torque demand generator 23. This generates the component of the assistance torque requested by the user dependent upon the torque they are applying to the steering column 5 using the steering wheel—the assistance component—and so is dependent upon the input torque signal T_{D}.

In the torque demand generator, the input torque signal is split into high and low frequency components by means of a low pass filter referred to as a blending filter. The low frequency components are passed through a boost curve, which is dependent upon the vehicle speed V. The shape and gradient of the boost curve is one of the features that are selectable for different steering feels. Typically, the boost curve will be a quadratic curve or an approximation thereto.

The boost curve may be as shown in FIG. 2, and be symmetric and continuous and comprise, moving away from zero torque, a linear section with width in torque p0, and gradient pd, a quadratic section with width p1 and gradient at its lowest point is pd and at its highest point is p2; there then follows a linear section of gradient p2 which extends to a torque of p3; next follows a quadratic section of width in torque p4 which starts at gradient p2 and finishes at gradient p5; finally, a linear section having gradient p5. Each of pd, p1, p2, p3, p4 and p5 may be varied for differing steering feels, and can be different for different vehicle speeds V.

The high frequency components are separately mapped, using a vehicle-speed dependent map to form a high frequency assistance component. The output of the boost curve and the high frequency assistance component are added together and then filtered using a stabilising adaptive torque filter. The output of the adaptive provides the assistance component of the assistance torque.

The next component is a yaw damping component, calculated by yaw damping generator 24. The yaw damping component is provided in order to damp the steering column to order to prevent vehicle yaw oscillations which can occur if the steering wheel is pulled and released whilst the vehicle is travelling at speed. The component is based upon a filtered product of the differential with time of the input torque signal and the column velocity, as disclosed in WO2003/086839, the disclosure of which is hereby incorporated by reference.

The final component is a torque damping component, calculated by torque damping generator 25. The torque damping component is provided in order to damp upper steering column resonance, and to reduce the level of disturbance from the road wheels, such as shimmy. In this filter, the column torque is differentiated, and passed through a high pass filter. The filter is as disclosed in WO2007/060435, the disclosure of which is hereby incorporated by reference.

The three components, the assistance component, the yaw damping component and the torque damping component are combined together in adding unit 26. This combines the three components together additively; the yaw damping component is subtracted from the sum of the other two components. The result is the assistance torque T₁, T₂ for that subcontroller 20, 21.

Certain torque components are provided in common for the two subcontrollers 20, 21. The first component, the high speed damping component T_{HS}, is generated by the high speed damping generator 17. The purpose of the high speed damping torque is to reduce the assistance torque as the column velocity ω exceeds a vehicle speed (V) dependent threshold. The damping torque is generated to counteract the fast steering movement similar to a spring coil action and proportionately dampen it. This typically avoids the damage to the gear assembly by preventing the rack from hitting the end stops due to excessive steer.

The high speed damping component is zero for a range of steering column velocities ω bounding zero velocity. The size of this deadband is vehicle speed V dependent. It increases linearly with increasing steering column velocity from zero at the edge of the deadband until a maximum value is reached; the gradient of this linear section depends upon the vehicle speed V.

The pull drift compensation component T_{PDC} is generated by pull drift compensation generator 18. The pull drift compensation at least partially compensates for any pull on the steering due to suspension misalignment. The component is calculated using the input torque signal TD, the vehicle speed V and the value of the assistance torque demand excluding the pull drift compensation component T_{PDC}, according to the method disclosed in WO2008/044010, the disclosure of which is hereby incorporated by reference.

The blending unit 22 comprises a combining unit 28 and a tune personalisation device 29, which controls the functions of the blending unit 22. The combining unit is arranged so as to add the assistance torques T₁ and T₂ together to form the assistance torque demand according to:

T_{A}=αT₁+(1−α)T₂+T_{HS}+T_{PDC},

where α is a function of time varying from 0 to 1 controlled by the tune personalisation device 29, as described below.

Generally, only one controller will be running at any given time. Thus, the output of the blending unit 22—that is the assistance torque demand T_{A}—will include the assistance torque of whichever controller is functioning at that time (that is α will be 0 or 1) but not the other. However, should the user desire to change the steering feel, the method shown in FIG. 4 is carried out in the blending unit 22.

Once a user has commanded a change in steering feel, the tune personalisation device 29 loads (in steps 30, 31 and 32 of FIG. 4) the parameters for the desired steering feel into the non-running subcontroller 20, 21. Once the non-running subcontroller has been loaded with the appropriate parameters, it is commenced running, and will output the assistance torque to the blending unit 22.

However, at the present time, a is being held at one extreme (say, for example, 0) and so the output of the recently initialised subcontroller will be excluded from the assistance torque demand T_{A}. This remains the case until certain criteria are met (steps 33 and 34). The criteria are that:
a predetermined length of time has passed since the recently commenced subcontroller commenced running;
the absolute value of the steering column velocity ω is less than a threshold;
the absolute value of the input torque signal T_{D} is less than a threshold; and
the absolute value of the vehicle speed V is less than a threshold.

Once these criteria are met, the blending procedure enters an initialisation phase (step 35). In this step, the difference between the assistance torques T₁ and T₂ from the two subcontrollers 20, 21 is determined. This difference is used to set the time period over which the blending procedure will take place, such that the average change per unit time is at a predetermined rate; for each unit of difference between T₁ and T₂, an extra period will be allowed for the blending process.

Blending then commences at steps 36 and 37. The value a is varied in line with the sigmoid curve shown in FIG. 5 of the accompanying drawings, such that a is varied smoothly from 0 to 1 (or vice versa) over the set time period. At the end of the set period (step 38) the previously non-running subcontroller will be providing the assistance torque demand T_{A}, with the output of the other subcontroller excluded from T_{A}. The latter controller can then be deactivated and stopped calculating until the next change of steering feel is required.

By blending the torque in this manner, with two live subcontrollers, not only can the system avoid sharp changes in the assistance torque demand (because the rate at which the torque can change is limited by the selection of the blending period), but also sharp changes in the steering dynamics (that is, how the system responds to user or other steering inputs). Asymmetry in the assistance torque can also be avoided.

1-14. (canceled)

15. A controller for an electric power assisted steering system comprising a steering mechanism which operatively connects a steering wheel to road wheels of a vehicle, and an electric motor operatively connected to the steering mechanism in order to apply an assistance torque to the steering mechanism, the controller having an input for an input torque signal indicative of the torque applied by a user to the steering mechanism and an output for an assistance torque demand indicative of the assistance torque to be applied to the steering mechanism by the electric motor,
in which the controller comprises:
a first subcontroller having an input for the input torque signal, an output for a first assistance torque and a processor arranged to determine the first assistance torque based upon the input torque signal;
a second subcontroller having an input for the input torque signal, an output for a second assistance torque and a processor arranged to determine the second assistance torque based upon the input torque signal; and
a blending unit, which has an input for each of the first and second assistance torques and which provides as an output the assistance torque demand, the blending unit arranged to combine the first and second assistance torques in time-varying proportions in order to determine the assistance torque demand.

16. The controller of claim 15, in which each of the first and second subcontrollers have an active state, in which the respective subcontroller determines the respective assistance torque dependent upon the input torque signal and an inactive state where the subcontroller does not determine the respective assistance torque.

17. The controller of claim 16, in which at least one of the first and second subcontrollers may be in the active state at any given time whilst the controller is being used.

18. The controller of claim 16, in which, should one of the subcontrollers be in the inactive state, the blending unit is arranged so as to exclude the output of subcontroller in the inactive state from the assistance torque demand.

19. The controller of claim 16, in which the blending unit is arranged to as to exclude the output of a subcontroller that has switched from the inactive state to the active state until any or all of the following criteria are satisfied: a predetermined period of time has elapsed since the subcontroller entered the active state; the speed of the vehicle is less than a threshold; the speed of part of the steering mechanism is less than a threshold; and the input torque signal is less than a threshold.

20. The controller claim 15, in which the blending unit is arranged so as to introduce an increasing proportion in the assistance torque demand of the assistance torque of one subcontroller, as it decreases the proportion in the assistance torque demand of the other subcontroller.

21. The controller of claim 20, in which the blending unit is arranged such that the proportions introduced by the blending unit vary from entirely from one subcontroller to entirely from the other subcontroller and the period of which this occurs depends upon the difference between the first and second assistance torques.

22. The controller of claim 15, in which the blending unit further comprises at least one input for at least one additional torque demand, which the blending unit is arranged to combine with the first and second assistance torques in order to provide the assistance torque demand.

23. An electric power assisted steering system for a vehicle, comprising:
a steering mechanism arranged to operatively connect a steering wheel to road wheels of the vehicle;
an electric motor operatively connected to the steering mechanism in order to apply an assistance torque to the steering mechanism; and
a controller having an input for an input torque signal indicative of the torque applied by a user to the steering mechanism and an output for an assistance torque demand indicative of the assistance torque to be applied to the steering mechanism by the electric motor,
in which the controller comprises:
a first subcontroller having an input for the input torque signal, an output for a first assistance torque and a processor arranged to determine the first assistance torque based upon the input torque signal;
a second subcontroller having an input for the input torque signal, an output for a second assistance torque and a processor arranged to determine the second assistance torque based upon the input torque signal; and
a blending unit, which has an input for each of the first and second assistance torques and which provides as an output the assistance torque demand, the blending unit arranged to combine the first and second assistance torques in time-varying proportions in order to determine the assistance torque demand;
in which the controller is arranged to control the assistance torque applied to the steering mechanism by the electric motor according to the assistance torque demand.

24. A method of operating an electric power assisted steering system comprising a steering mechanism which operatively connects a steering wheel to road wheels of a vehicle, and an electric motor operatively connected to the steering mechanism in order to apply an assistance torque to the steering mechanism,
the method comprising:
measuring an input torque indicative of the torque applied by a user to the steering mechanism;
determining, from the input torque, a first assistance torque;
at the same time determining, from the input torque, a second assistance torque;
blending the first and second assistance torques in time-varying proportions in order to determine the assistance torque demand;
and operating the motor in accordance with the assistance torque demand.

25. The method of claim 24, comprising the step of only determining one of the first or second assistance torques for a period of time.

26. The method of claim 25, in which only the assistance torque that is being determined will be included in the assistance torque demand during that period of time.

27. The method of claim 25, in which the step of blending comprises excluding an assistance torque determination of which has been commenced until any or all of the following criteria are satisfied: a predetermined period of time has elapsed after the period of time in which only one of the assistance torques has been determined; the speed of the vehicle is less than a threshold; the speed of part of the steering mechanism is less than a threshold; and the input torque is less than a threshold.

28. The method of claims 24, in which the step of blending further comprises combining at least one additional torque demand with the first and second assistance torques in order to provide the assistance torque demand. This will allow components calculated independently of the first and second subcontrollers to be included in the assistance torque demand.
